(19) United States
(12) Patent Application Publication
(10) Pub. No.: US 2026/0251951 A1
(43) Pub. Date: Aug. 27, 2026

(54) CAMERA MODULE

(71) Applicant: Samsung Electro-Mechanics Co., Ltd., Suwon-si (KR)

(72) Inventors: Tae Won KANG, Suwon-si (KR); Hong Joo LEE, Suwon-si (KR)

(73) Assignee: Samsung Electro-Mechanics Co., Ltd., Suwon-si (KR)

(21) Appl. No.: 19/430,918

(22) Filed: Dec. 23, 2025

(30) Foreign Application Priority Data
Feb. 25, 2025 (KR) 10-2025-0024526

(51) Int. Cl. G03B 5/00

(52) U.S. Cl. CPC G03B 5/00; G03B 2205/0007

(57) ABSTRACT

A camera module includes a housing; a reflective member disposed within the housing and configured to change an optical path; a lens module including a carrier movable along an optical axis direction, the carrier including a concave portion on a side surface and at least one lens disposed therein; a case coupled to the housing to cover the reflective member and the lens module; and a first damper disposed on an inner surface of the housing or the case and having at least a portion accommodated within the concave portion.

### CROSS-REFERENCE TO RELATED APPLICATIONS

This application claims the benefit under 35 USC 119(a) of Korean Patent Application No. 10-2025-0024526 filed on Feb. 25, 2025, in the Korean Intellectual Property Office, the entire disclosure of which is incorporated herein by reference for all purposes.

### BACKGROUND

### 1. Field

The present disclosure relates to a camera module.

### 2. Description of the Background

Camera modules are adopted in portable electronic devices, such as smartphones, tablet PCs, and laptops.

In addition, in order to miniaturize and thin portable electronic devices, camera modules in which a reflective member is disposed in front of a lens module to bend an optical path have been widely used.

Most camera modules have an autofocusing function. However, as the performance of an actuator for driving autofocusing increases, the weight of a driving unit may increase, causing noise problems (i.e., buzz, squeak, or rattle) and breakage due to impact between components.

Accordingly, it may be desirable to provide a camera module that uses a damper to reduce impact between components, while still maintaining sufficient driving force for autofocus.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing; a reflective member disposed within the housing and configured to change an optical path; a lens module including a carrier movable along an optical axis direction, the carrier including a concave portion on a side surface and at least one lens disposed therein; a case coupled to the housing to cover the reflective member and the lens module; and a first damper disposed on an inner surface of the housing or the case and having at least a portion accommodated within the concave portion.

The camera module may further include a second damper fixed to the housing and facing an outer surface of the carrier along the optical axis direction.

A maximum gap between the first damper and an inner surface of the concave portion may be smaller than a maximum gap between the second damper and the outer surface of the carrier in the optical axis direction.

In response to the carrier moving to a maximum driving range in the optical axis direction, the carrier may sequentially contact the first damper and the second damper.

The first damper may include a first fixing portion fixed to the case and a first buffer portion coupled to the first fixing portion.

The first buffer portion may face an inner surface of the concave portion in the optical axis direction.

The first fixing portion may include a first region in contact with the case and a second region extending in a first direction from the first region to both sides in the optical axis direction different from the first direction.

The first fixing portion may include a non-magnetic metal material, and the first buffer portion may include an elastic material.

The concave portion may be disposed on both side surfaces at an outer surface of the carrier facing each other in a direction perpendicular to the optical axis direction. The first damper may include a plurality of first dampers respectively accommodated in the concave portion on both side surfaces of the carrier.

The second damper may include a second fixing portion fixed to the housing and a second buffer portion coupled to the second fixing portion.

The carrier may include an opening connected to the concave portion and open toward the case, and the first damper may be integrally formed and at least a portion of the first damper is accommodated in the opening.

The first damper may face the inner surface of the opening in the optical axis direction.

A maximum gap between the first damper and an inner surface of the opening may be smaller than a maximum gap between the second damper and the outer surface of the carrier.

The first damper may be disposed in an accommodation recess disposed on the inner surface of the case.

In another general aspect, a camera module include a housing; a reflective member disposed within the housing and configured to change an optical path; a lens module comprising a carrier movable along an optical axis direction, and at least one lens disposed in the carrier; a case coupled to the housing to cover the reflective member and the lens module; and a first damper disposed on an inner surface of the housing or the case and having both end portions facing the carrier in the optical axis direction.

The carrier may include a concave portion disposed on a side surface, and an opening connected to the concave portion and open toward the housing. The first damper may be accommodated in the concave portion through the opening.

Other features and aspects will be apparent from the following detailed description, the drawings, and the claims.

### BRIEF DESCRIPTION OF DRAWINGS

FIG. 1 is a perspective view of a portable electronic device equipped with a camera module according to an embodiment of the present disclosure.

FIG. 2 is a perspective view of a camera module according to a first embodiment of the present disclosure.

FIG. 3 is an exploded perspective view of a camera module according to the first embodiment of the present disclosure.

FIG. 4 is an exploded perspective view illustrating some components separated from FIG. 1.

FIG. 5 is a cross-sectional view taken along line I-I′ of FIG. 1.

FIG. 6 is an enlarged view of region A of FIG. 5.

FIG. 7 is a diagram illustrating a case in which a carrier of FIG. 6 has moved to one side.

FIG. 8 is a diagram illustrating a case in which the carrier of FIG. 6 has moved to the other side.

FIG. 9 is a cross-sectional view of a camera module according to a second embodiment of the present disclosure, which corresponds to FIG. 5.

FIG. 10 is an enlarged view of region B of FIG. 9.

FIG. 11 is a diagram illustrating a case in which a carrier of FIG. 10 has moved to one side.

FIG. 12 is a diagram illustrating a first damper included in a camera module according to the second embodiment of the present disclosure.

FIG. 13 is a cross-sectional view of a camera module according to a third embodiment of the present disclosure, which corresponds to FIG. 5.

FIG. 14 is an enlarged view of region C of FIG. 13.

FIG. 15 is a diagram illustrating a case in which a carrier of FIG. 14 has moved to one side.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

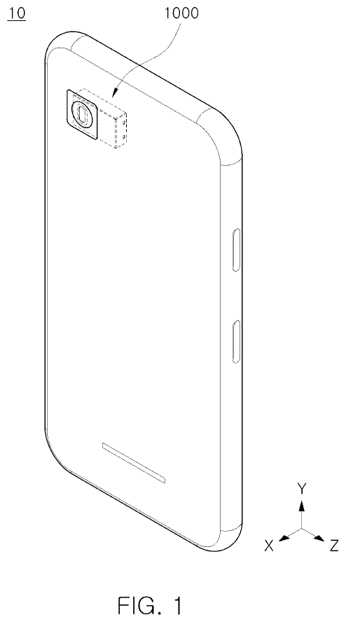

FIG. 1 is a perspective view of a portable electronic device 10 equipped with a camera module according to an embodiment of the present disclosure.

Referring to FIG. 1, a camera module 1000 according to an embodiment of the present disclosure may be mounted on a portable electronic device 10. The portable electronic device 10 may be a portable electronic device, such as a mobile communication terminal, a smartphone, or a tablet PC.

As illustrated in FIG. 1, a camera module 1000 is mounted on the portable electronic device 10 to image a subject.

In the present embodiment, the camera module 1000 includes a plurality of lenses. An optical axis (the Z-axis) of the plurality of lenses may be directed in a direction, perpendicular to a thickness direction of the portable electronic device 10 (the X-axis direction, a direction from a front surface of the portable electronic device to a rear surface thereof, or the opposite direction).

As an example, the optical axis (the Z-axis) of the plurality of lenses provided in the camera module 1000 may be formed in a width direction or a length direction of the portable electronic device 10.

Therefore, even if the camera module 1000 has functions, such as autofocusing (AF), optical zoom (zoom), and OIS, the thickness of the portable electronic device 10 may not increase. Accordingly, the portable electronic device 10 may be made thinner.

The camera module 1000, according to an embodiment of the present disclosure, may be equipped with at least one of the AF, zoom, and OIS functions.

Since the camera module 1000 equipped with the AF, zoom, and OIS functions has to be equipped with various components, the size of the camera module increases, as compared to general camera modules.

The increase in the size of the camera module 1000 may lead to a problem in miniaturizing the portable electronic device 10 equipped with the camera module 1000.

For example, when a plurality of lenses are disposed in the thickness direction of the portable electronic device, the thickness of the portable electronic device may also increase according to the number of lenses. Accordingly, there is a problem that the thickness of the portable electronic device has to be increased in order to secure a sufficient number of lenses.

However, in the camera module 1000 according to an embodiment of the present disclosure, the plurality of lenses are disposed such that the optical axis (the Z-axis) thereof is perpendicular to the thickness direction (the X-axis direction) of the portable electronic device 10, and thus, the portable electronic device 10 may be made thinner.

The camera module 1000, according to an embodiment of the present disclosure, may have a dual damping structure that may alleviate noise and shocks that may occur due to driving in the optical axis (the Z-axis) direction of a lens module 300. In one example, a concave portion 311 in which a first damper 500 is partially accommodated is formed in a carrier 310 included in the lens module 300, so that a collision of the concave portion 311 and the first damper 500 may occur before a collision of an outer surface of the carrier 310 and a second damper 600.

Hereinafter, each component of the camera module 1000 according to an embodiment of the present disclosure will be described in detail with reference to the drawings.

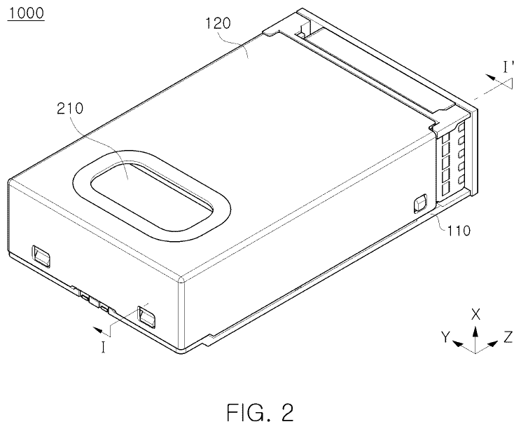

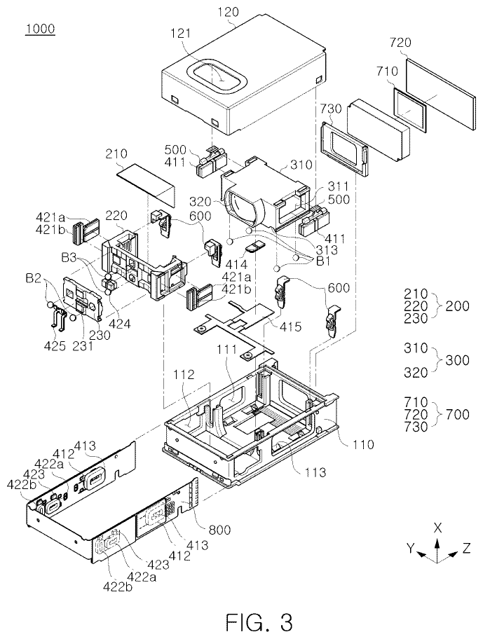

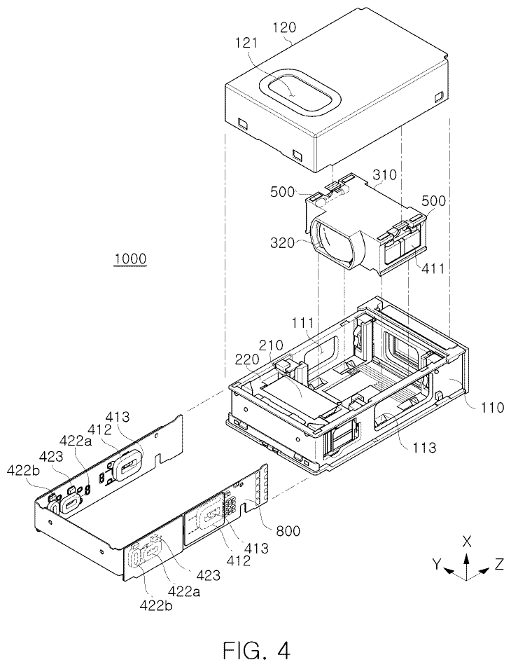

FIG. 2 is a perspective view of the camera module 1000 according to a first embodiment of the present disclosure. FIG. 3 is an exploded perspective view of the camera module 1000 according to the first embodiment of the present disclosure. FIG. 4 is an exploded perspective view illustrating some components separated from FIG. 1.

Referring to FIGS. 2 to 4, the camera module 1000 according to an embodiment of the present disclosure may include a housing 110, a reflective module 200 disposed in the housing 110, the lens module 300, and an image sensor module 700.

The reflective module 200 may change the traveling direction of light. The reflective module 200 may include a reflective member 210 that changes the path of light. For example, the reflective member 210 may be provided as a prism, a mirror, etc.

Light incident through a through-hole 121 of a case 120 disposed to cover an upper portion of the housing 110 may be changed along the traveling direction from the reflective module 200 to the lens module 300 by the reflective member 210.

Light incident in the thickness direction (the X-axis direction) of the camera module 1000 may be changed along the path by the reflective module 200 to the optical axis (the Z-axis) direction and may be incident on the lens module 300.

The lens module 300 may include a plurality of lenses arranged along the optical axis (the Z-axis) direction. The lens module 300 of the present embodiment may include a carrier 310 being movable in the optical axis (the Z-axis) direction along the optical path and including a concave portion 311 on an outer surface thereof and at least one lens 320 disposed in the carrier 310. The plurality of lenses may be mounted directly on the carrier 310 or may be mounted on the carrier 310 via a lens barrel.

The image sensor module 700 may include an image sensor 710 converting light passing through the lens module 300 into an electric signal and a printed circuit board (PCB) 720 on which the image sensor 710 is mounted. In addition, the image sensor module 700 may include an optical filter 730 filtering light incident on the image sensor 710. For example, the optical filter 730 may be an infrared cut filter.

Referring to FIGS. 2 and 3, the reflective module 200 may be provided in front of the lens module 300 (the −Z direction) in the housing 110, and the image sensor module 700 may be provided in the rear (the +Z direction) of the lens module 300.

In addition, a second driving unit 420 for driving the reflective module 200, a first driving unit 410 for driving the lens module 300, and a main board 800 for supplying power or transmitting and receiving a control signal to the image sensor 710 may be disposed on the outer surface of the housing 110.

The camera module 1000, according to an embodiment of the present disclosure, may implement an AF function as the lens module 300 moves in the optical axis (the Z-axis) direction.

The lens module 300 may include the carrier 310 on which a plurality of lenses are mounted. The lens module 300 of the present embodiment includes a single carrier 310, but without being limited thereto, and the lens module 300 may include a plurality of carriers 310. In addition, a plurality of lenses may be mounted directly on the carrier 310 or mounted on the carrier 310 via a lens barrel.

The AF function of the camera module 1000 may be implemented by the movement of the carrier 310 equipped with a plurality of lenses in the optical axis (the Z-axis) direction. When the carrier 310 is provided in plural, the AF and optical zoom functions may be implemented as one or more carriers move in the optical axis (the Z-axis) direction. The plurality of carriers may move independently.

The carrier 310 may be moved in the optical axis (the Z-axis) direction by the first driving unit 410.

Referring to FIGS. 3 and 4, the first driving unit 410 may include a plurality of magnets 411 and a plurality of coils 412 disposed to face the plurality of magnets 411. The magnets and coils may not need to be provided in plural, and one or more magnets and coils may be provided.

The magnets 411 are magnetized to have an N-pole and an S-pole (or vice versa) in order along the optical axis (the Z-axis) direction and may correspond to the coils 412, respectively.

When power is applied to the plurality of coils 412, the carrier 310 may move in the optical axis (the Z-axis) direction by an electromagnetic influence between the plurality of magnets 411 and the plurality of coils 412.

In an embodiment, the plurality of magnets 411 is respectively disposed on both sides of the carrier 310, and the plurality of coils 412 may be respectively disposed on both sides of the housing 110 to face the plurality of magnets 411.

In addition, the plurality of coils 412 may be mounted on the main board 800, and the main board 800 may be disposed on an outer surface of the housing 110. The housing 110 may include a through-hole 111 exposing the plurality of coils 412 to the inside of the housing 110 so that the plurality of magnets 411 and the plurality of coils 412 directly face each other.

The first driving unit 410 may include a position sensor 413 detecting a position of the carrier 310. For example, the position sensor 413 may be a Hall sensor.

The position sensor 413 may be disposed on the inside or outside of the coil 412 and may be mounted on the main board 800 together with the coil 412.

Meanwhile, the carrier 310 may smoothly move in the optical axis (the Z-axis) direction on a bottom surface of the housing 110 through a plurality of ball members B1. The plurality of ball members B1 may be provided as three or more ball members.

For example, an inner surface of the housing 110 and a bottom surface of the carrier 310 may be provided with guide recesses 113 and 313 extending in the optical axis (the Z-axis) direction, respectively. The plurality of ball members B1 may be inserted between the guide recesses 113 and 313 to guide the movement of the carrier 310, while rolling in the optical axis (the Z-axis) direction along the guide recesses 113 and 313.

The camera module 1000 may include a pulling unit for pulling the carrier 310 toward the bottom surface of the housing 110 so that the plurality of ball members B1 may continuously contact the guide recesses 113 and 313 while the carrier 310 moves.

The pulling units may be arranged to face each other on the carrier 310 and the housing 110. For example, the pulling unit may include a magnetic member, with a pulling magnet 414 provided on the carrier 310 and a pulling yoke 415 provided on the housing 110. Alternatively, the positions of the pulling magnet 414 and the pulling yoke 415 may be interchanged. The pulling magnet 414 and the pulling yoke 415 may generate an attractive force along the X-axis direction in opposite directions.

The movement of the carrier 310 in the optical axis (the Z-axis) direction may be a relative movement with respect to the housing 110. Therefore, when the carrier 310 moves in the optical axis (the Z-axis) direction, a gap between the carrier 310 and the housing 110 as a counterpart may decrease.

The camera module 1000 of the present embodiment may include a second damper 600 limiting the movement distance of the carrier 310 to prepare for a collision between the carrier 310 and the housing 110.

The second damper 600 may be disposed on the housing 110 to face the carrier 310 in the optical axis (the Z-axis) direction. The carrier 310 may come into contact with the second damper 600 instead of the housing 110.

Meanwhile, the camera module 1000, according to an embodiment of the present disclosure, may implement an OIS function by rotating the reflective module 200.

When capturing an image or video, blurring or shaking may occur due to a user's hand shaking or other movement. The camera module 1000 may compensate for such shaking by rotating the reflective module 200 in a direction that offsets the movement.

Referring to FIG. 3, the reflective module 200 of the present embodiment may include a holder 220 on which a reflective member 210 is mounted.

The holder 220 may be rotatably accommodated in the housing 110. For example, the holder 220 may be rotated about a first axis (the X-axis) and a second axis (the Y-axis), perpendicular to the optical axis (the Z-axis), while accommodated in the housing 110. The OIS function of the camera module 1000 may be implemented by the rotation of the holder 220.

The reflective module 200 may include a guide member 230 disposed between the holder 220 and the housing 110.

In an embodiment, a second ball member B2 may be disposed between the housing 110 and the guide member 230, and a third ball member B3 may be disposed between the guide member 230 and the holder 220.

One surface of the guide member 230 may be disposed spaced apart from an inner surface of the housing 110 with the second ball member B2 therebetween. A recess may be formed on each of the facing surfaces of the guide member 230 and the housing 110 to accommodate the second ball member B2.

The second ball member B2 may maintain a gap between the inner surface of the housing 110 and the guide member 230. In addition, the second ball member B2 may be disposed parallel to the second axis (the Y axis), which is a rotational axis of the holder 220.

In an embodiment, the second ball member B2 may include two ball members spaced apart from each other in the direction of the second axis (the Y-axis). The second ball member B2 may serve as a rotating shaft while rotating in place in a state of being inserted between recesses respectively formed on the surfaces of the guide member 230 and the housing 110.

Meanwhile, the other surface of the guide member 230 may be spaced apart from the holder 220 with the third ball member B3 interposed therebetween. A recess may be formed on each of the facing surfaces of the guide member 230 and the holder 220. The third ball member B3 may be inserted between the recesses formed in the facing surfaces of the guide member 230 and the holder 220.

The third ball member B3 may maintain a gap between the holder 220 and the guide member 230. In addition, the third ball member B3 may be disposed parallel to the first axis (the X-axis), which is another rotational axis of the holder 220.

In an embodiment, the third ball member B3 may include two ball members spaced apart from each other in the direction of the first axis (the X-axis). The third ball member B3 may serve as a rotational axis while rotating in place in a state of being inserted between the recesses formed in the facing surfaces of the guide member 230 and the holder 220.

In an embodiment, the holder 220 may be supported by the guide member 230 with the third ball member B3 therebetween, and the guide member 230 may be supported on the inner surface of the housing 110 with the second ball member B2 therebetween. To this end, the camera module 1000 of the present embodiment may include a pulling unit for pulling the holder 220 toward the inner surface of the housing 110.

The pulling unit may be disposed to face each other on the holder 220 and the housing 110. For example, the pulling unit may be provided as a magnetic member, and a pulling magnet 424 may be disposed on the holder 220 and a pulling yoke 425 may be disposed on the housing 110. Of course, the positions of the pulling magnet 424 and the pulling yoke 425 may be interchanged.

The guide member 230 disposed between the holder 220 and the housing 110 may include a through-hole 231, and the pulling magnet 424 and the pulling yoke 425 may face each other through the through-hole 231. The pulling magnet 424 and the pulling yoke 425 may generate an attractive force in the opposite direction (the Z-axis direction). By the attractive force between the pulling magnet 424 and the pulling yoke 425, the second ball member B2 and the third ball member B3 may be continuously in contact with the recesses in which they are seated.

The holder 220 equipped with the reflective member 210 may be rotated about the first axis (the X-axis) and the second axis (the Y-axis) by the second driving unit 420. In an embodiment, when the holder 220 is rotated about the second axis (the Y-axis), the guide member 230 may also be rotated together, and the rotation of the holder 220 about the first axis (the X-axis) may be a relative rotation with respect to the guide member 230. However, the present disclosure is not limited thereto, and when the positions of the second ball member B2 and the third ball member B3 are mutually changed, the guide member 230 may be rotated about the first axis (the X-axis) together with the holder 220, and the rotation of the holder 220 about the second axis (the Y-axis) may be a relative rotation with respect to the guide member 230.

Referring to FIGS. 3 and 4, the second driving unit 420 may include a plurality of magnets 421a and 421b and a plurality of coils 422a and 422b disposed to face the plurality of magnets 421a and 421b.

The plurality of magnets 421a and 421b may include a first driving magnet 421a rotating the holder 220 about the second axis (the Y-axis) and a second driving magnet 421b rotating the holder 220 about the first axis (the X-axis).

In an embodiment, the first driving magnet 421a and the second driving magnet 421b may be provided in two units each and may be mounted on both sides of the holder 220. That is, the first driving magnet 421a and the second driving magnet 421b may be disposed on one side of the holder 220. For example, the first driving magnet 421a and the second driving magnet 421b may be disposed parallel to the optical axis (the Z-axis) direction.

The first driving magnet 421a may be magnetized to have an N-pole and an S-pole (or vice versa) in order in the second axis (the Y-axis) direction, and the second driving magnet 421b may be magnetized to have an N-pole and an S-pole (or vice versa) in order in the first axis (the X-axis) direction.

The plurality of coils 422a and 422b may include a first driving coil 422a disposed to face the first driving magnet 421a and a second driving coil 422b disposed to face the second driving magnet 421b. The first driving coil 422a and the second driving coil 422b may correspond to the first driving magnet 421a and the second driving magnet 421b in a one-to-one manner.

When power is applied to the plurality of coils 422a and 422b, the holder 220 may be rotated about the second axis (the Y-axis) and/or the first axis (the X-axis) by an electromagnetic influence between the plurality of magnets 421a and 421b and the plurality of coils 422a and 422b facing each other.

The plurality of coils 422a and 422b is mounted on the main board 800, and the main board 800 may be disposed on the outer surface of the housing 110. The housing 110 may include a through-hole 112 exposing the plurality of coils 422a and 422b to the inside of the housing 110 so that the plurality of magnets 421a and 421b and the plurality of coils 422a and 422b directly face each other.

The second driving unit 420 may include a position sensor 423 detecting a position of the holder 220. For example, the position sensor 423 may be a Hall sensor.

The position sensor 423 may be mounted on the main board 800 together with the plurality of coils 422a and 422b. The position sensor 423 may be disposed on the outside of the plurality of coils 422a and 422b and may be spaced apart from the first driving coil 422a in the first axial direction (the X-axis direction).

Referring to FIG. 4, the carrier 310 of the present embodiment may be limited in a movement displacement by the second damper 600, while driven in the optical axis (the Z-axis) direction in a space between the reflective module 200 in the housing 110 and the image sensor module 700.

In the camera module 1000 according to an embodiment of the present disclosure, noise may be reduced and shock alleviated because initial damping occurs by means of the first damper 500, which is fixed to the case 120, engaging with the concave portion 311 formed on the side surface of the carrier 310.

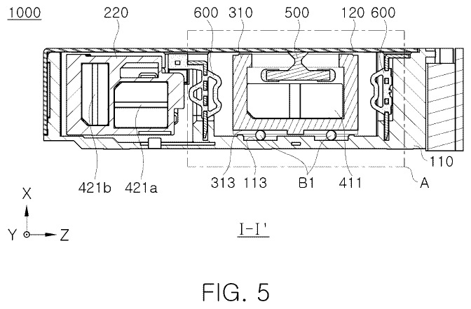

Hereinafter, a dual damping structure according to the movement of the lens module 300 in the optical axis (the Z-axis) direction will be described in detail with reference to FIGS. 5 to 8.

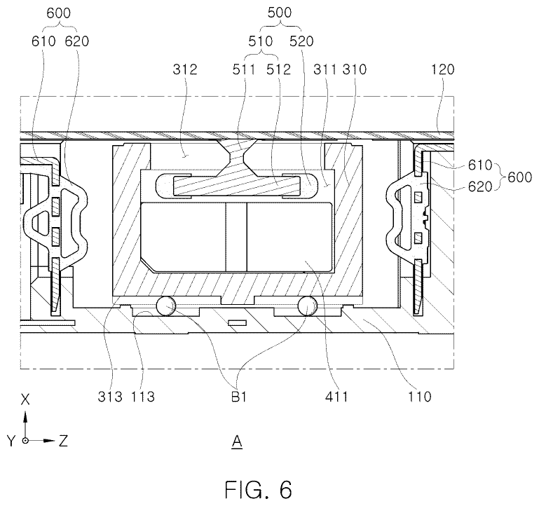

FIG. 5 is a cross-sectional view taken along line I-I′ of FIG. 1. FIG. 6 is an enlarged view of region A of FIG. 5.

Referring to FIGS. 4 and 5, the camera module 1000 according to the present embodiment may include the housing 110 and the carrier 310 disposed in the housing 110. The carrier 310 of the present embodiment may have the concave portion 311 formed on the side thereof. The concave portion 311 of the present embodiment may be symmetrically disposed on both sides of the carrier 310 facing each other in the second axis (the Y-axis) direction, and the magnet 411 for driving the carrier 310 in the optical axis (the Z-axis) direction may be disposed in the concave portion 311. In addition, the carrier 310 may include an opening 312 connected to the concave portion 311 and open toward the case 120. The opening 312 corresponds to an entrance connected to the concave portion 311 in the first axis (the X-axis) direction and is a region through which the first damper 500 may pass.

According to an embodiment of the present disclosure, in the camera module 1000, the first damper 500 is accommodated in an upper space remaining after the magnet 411 is accommodated in the concave portion 311, thereby alleviating the impact in the optical axis (the Z-axis) direction through a collision between the inner surface of the concave portion 311 and the first damper 500. The first damper 500 of the present embodiment may have both end portions in the optical axis (the Z-axis) direction facing the carrier 310.

Referring to FIGS. 4 to 6, the first damper 500 of the present embodiment may be fixed to the case 120 coupled to the housing 110. At least a portion of the first damper 500 may be accommodated in the concave portion 311. In addition, the first damper 500 may be formed in plural, and the plurality of first dampers 500 may be accommodated in the concave portions 311 on both sides of the carrier 310, respectively. However, without being limited thereto, and a single first damper 500 accommodated in only one concave portion 311 may be disposed. Meanwhile, the first damper 500 may be fixed to the housing 110, and a third embodiment having such a structure will be described below.

The first damper 500 may include a first fixing portion 510 fixed to the case 120 and a first buffer portion 520 coupled to the first fixing portion 510.

The first fixing portion 510 may be configured to firmly support the first damper 500 and may be formed of a non-magnetic metal material. For example, the first fixing portion 510 may include at least one of SUS, Al, Ti, Cu, and Cu-Zn, but is not limited thereto. The first fixing portion 510 may be integrated with the case 120 through welding.

Referring to FIG. 6, the first fixing portion 510 of the present embodiment may include a first region 511 that contacts the case 120, and a second region 512 that extends from the first region 511 to both sides along the optical axis (the Z-axis) direction. That is, the first fixing portion 510 may have an inverted T-shaped cross-section, in which the first region 511 extends in the first axis (the X-axis) direction and the second region 512 branches from the first region 511 to both sides.

In addition, the first buffer portion 520 may be coupled to the first fixing portion 510, and the first buffer portion 520 may be formed of an elastic material. The first buffer portion 520 may include a buffering material, such as, for example, a liquid crystal polymer (LCP), urethane, silicone, rubber, foam resin, epoxy, poly material, etc.

The first buffer portion 520 may be coupled to the second region 512 of the first fixing portion 510 and may be disposed to face an inner surface of the concave portion 311 in the optical axis (the Z-axis) direction. Through this structure, when the carrier 310 is driven in the optical axis (the Z-axis) direction, buffering between the first damper 500 and the inner surface of the concave portion 311 may be implemented.

Referring to FIGS. 5 and 6, the camera module 1000 according to the present embodiment may further include a second damper 600 fixed to the housing 110 and facing the outer surface of the carrier 310 in the optical axis (the Z-axis) direction.

The second damper 600 may be fixed to the housing 110 and may be disposed between the reflective module 200 and the lens module 300 and between the lens module 300 and the housing 110. The second damper 600 may have a function of limiting the maximum displacement when the lens module 300 is driven in the optical axis (the Z-axis) direction. In addition, the second damper 600 may secondarily alleviate the impact that has been primarily alleviated by the first damper 500, thereby reducing the risk of noise occurrence and component breakage.

The second damper 600 of the present embodiment may include a second fixing portion 610 fixed to the housing 110 and a second buffer portion 620 coupled to the second fixing portion 610.

The second fixing portion 610 may be configured to firmly support the second damper 600 and may be formed of a non-magnetic metal material. For example, the second fixing portion 610 may include at least one of SUS, Al, Ti, Cu, and Cu-Zn, but is not limited thereto. The second fixing portion 610 may be fitted into a recess formed in the housing 110 so as to be fixed. In addition, the second fixing portion 610 may have a wedge shape with a thickness that gradually decreases at the bottom, and in this case, the second fixing portion 610 may be easily fixed to the recess formed in the housing 110.

In addition, the second buffer portion 620 may be coupled to the second fixing portion 610, and the second buffer portion 620 may be formed of an elastic material. The second buffer portion 620 may include a buffering material, such as, for example, a liquid crystal polymer (LCP), urethane, silicone, rubber, foam resin, epoxy, poly material, etc.

The second buffer portion 620 may be coupled to the second fixing portion 610 and may be disposed to face the outer surface of the carrier 310 in the optical axis (the Z-axis) direction. Through this structure, the impact between the second damper 600 and the outer surface of the carrier 310 may be alleviated when the carrier 310 is driven in the optical axis (the Z-axis) direction.

Meanwhile, the second fixing portion 610 and the second buffer portion 620 may be formed separately and coupled such that the second buffer portion 620 is fitted into a hole formed in the second fixing portion 610, but without being limited thereto, and the second fixing portion 610 and the second buffer portion 620 may be formed integrally through a method, such as insert injection.

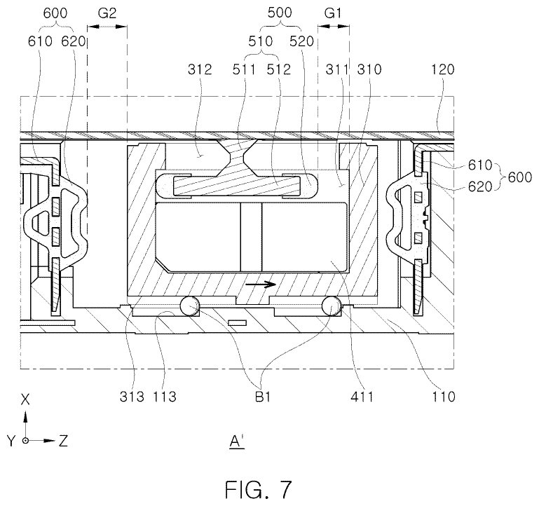

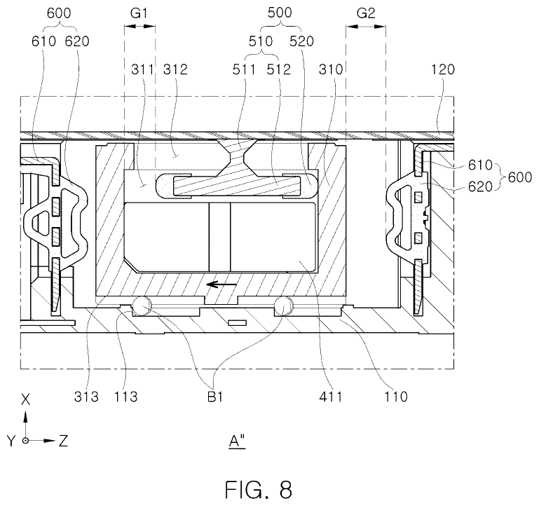

FIG. 7 is a diagram illustrating a case in which the carrier 310 of FIG. 6 moves to one side. FIG. 8 is a diagram illustrating a case in which the carrier 310 of FIG. 6 moves to the other side.

Referring to FIGS. 7 and 8, a maximum gap G1 between the first damper 500 and the inner surface of the concave portion 311 in the optical axis (the Z-axis) direction may be narrower than the maximum gap G2 between the second damper 600 and the outer surface of the carrier 310. Through this structure, when the carrier 310 moves to one side (the +Z direction), as in FIG. 7 or when the carrier 310 moves to the other side (the −Z direction), as in FIG. 8, a collision between the inner surface of the concave portion 311 and the first damper 500 may occur first. After the collision, a collision may occur between the outer surface of the carrier 310 and the second damper 600.

Therefore, when the carrier 310 moves to the maximum driving range in the optical axis (the Z-axis) direction, the carrier 310 may sequentially collide with the first damper 500 and the second damper 600. Through this dual damping structure, the impact applied to the carrier 310 and the counterpart in the optical axis (the Z-axis) direction may be effectively alleviated, and the risk of noise occurrence and breakage may also be reduced.

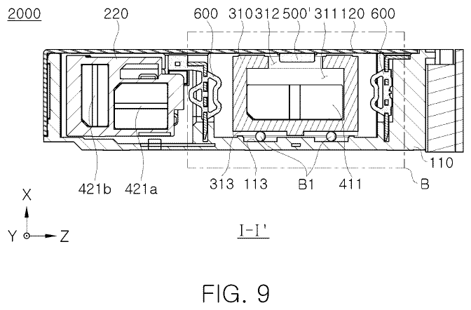

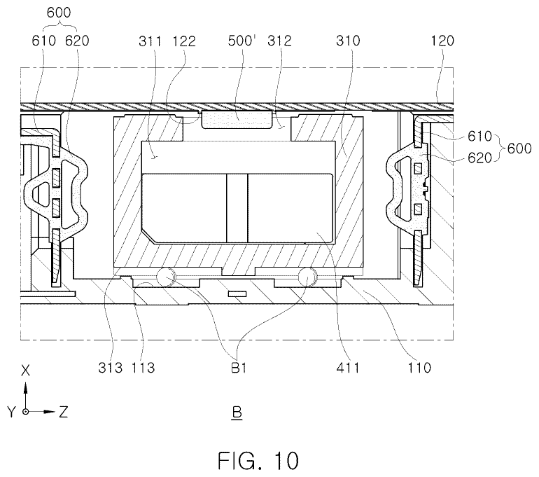

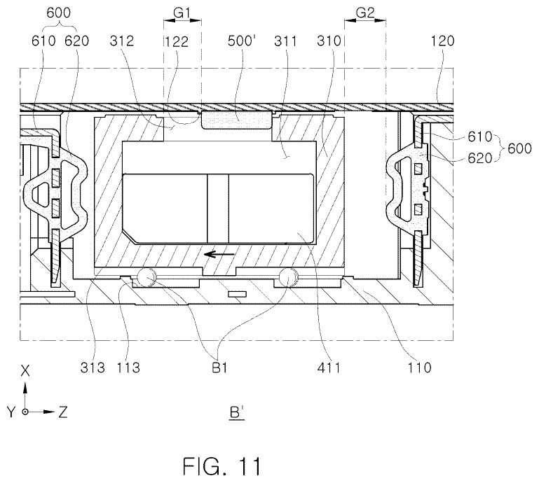

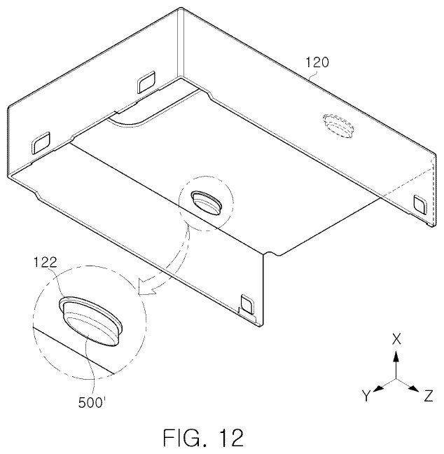

FIG. 9 is a cross-sectional view of a camera module 2000 according to a second embodiment of the present disclosure, which corresponds to FIG. 5. FIG. 10 is an enlarged view of region B of FIG. 9. FIG. 11 is a view illustrating a case in which the carrier 310 of FIG. 10 has moved to one side. FIG. 12 is a view illustrating a first damper 500′ included in the camera module 200 according to the second embodiment of the present disclosure.

The camera module 2000, according to the present embodiment, is different from the first embodiment in terms of the shape and arrangement of the first damper 500′, a damping region with the carrier 310, etc. Therefore, in describing the present embodiment, only the shape and arrangement of the first damper 500′, the damping region with the carrier 310, etc., which are different from the first embodiment of the present disclosure, will be described, and the same description in the first embodiment of the present disclosure may be applied as is to the other components.

Referring to FIGS. 9 to 12, the first damper 500′ of the present embodiment may be formed integrally and may be disposed in an accommodation recess 122 formed on the inner surface of the case 120. The first damper 500′ may be adhered to the accommodation recess 122 through an adhesive member so as to be fixed to the case 120.

The first damper 500′ may be formed of an elastic material. The first damper 500′ may include a material capable of buffering, such as a liquid crystal polymer (LCP), urethane, silicone, rubber, foam resin, epoxy, poly material, etc.

The first damper 500′ may have an oval cross-section, but without being limited thereto, the first damper 500′ may be applied variously as long as it has a shape capable of damping in the optical axis (the Z-axis) direction, such as an angular cross-section or a tapered cross-section.

The carrier 310 of the present embodiment may include the opening 312 connected to the concave portion 311 and being open toward the case 120, and at least a portion of the first damper 500′ may be accommodated in the opening 312. The first damper 500′ of the present embodiment may not be configured to extend through the opening 312 to the concave portion 311 but may be configured to damp the inner surface of the opening 312 in the optical axis (the Z-axis) direction. That is, the first damper 500′ may be disposed to face the inner surface of the opening 312 in the optical axis (the Z-axis) direction. Through this structure, a buffering function may be implemented between the first damper 500′ and the inner surface of the opening 312 when the carrier 310 is driven in the optical axis (the Z-axis) direction.

Referring to FIG. 11, the maximum gap G1 between the first damper 500′ and the inner surface of the opening 312 in the optical axis (the Z-axis) direction may be narrower than the maximum gap G2 between the second damper 600 and the outer surface of the carrier 310. Through this structure, when the carrier 310 moves in the optical axis (the Z-axis) direction, a collision may first occur between the inner surface of the opening 312 and the first damper 500′. After the collision, a collision may occur between the outer surface of the carrier 310 and the second damper 600.

Therefore, when the carrier 310 moves to the maximum driving range in the optical axis (the Z-axis) direction, the carrier 310 may sequentially collide with the first damper 500′ and the second damper 600. Through this dual damping structure, the impact applied to the carrier 310 and the counterpart in the optical axis (the Z-axis) direction may be effectively alleviated and the risk of noise occurrence and breakage may also be reduced.

Meanwhile, in the case of the present embodiment, since damping occurs in the opening 312 rather than in the concave portion 311 of the carrier 310, the same stroke interval may be secured even if the opening 312 of the carrier 310 is formed narrower than that in the first embodiment.

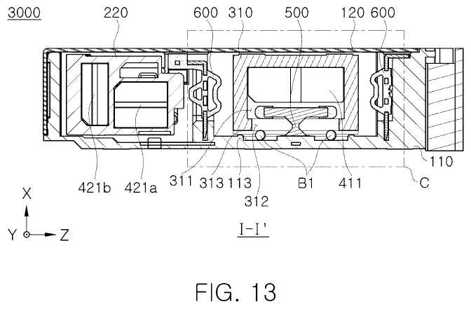

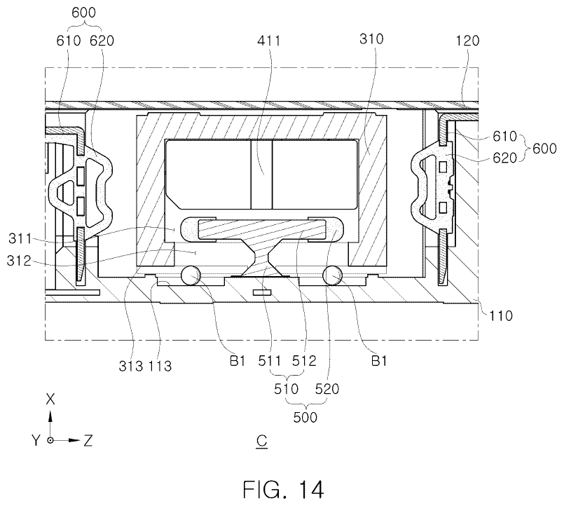

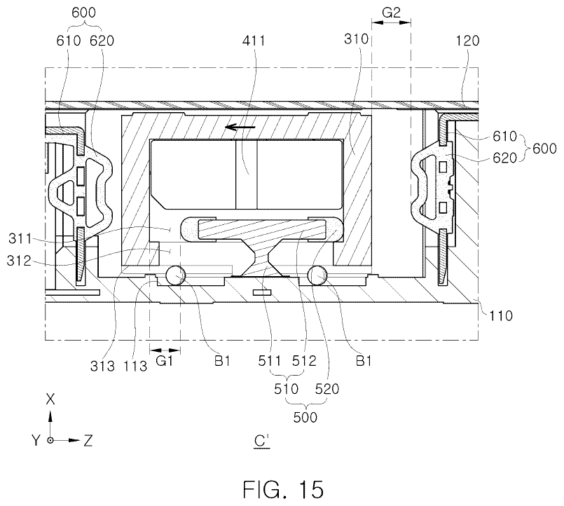

FIG. 13 is a cross-sectional view of a camera module 3000 according to a third embodiment of the present disclosure, which corresponds to FIG. 5. FIG. 14 is an enlarged view of region C of FIG. 13. FIG. 15 is a view illustrating a case in which the carrier 310 of FIG. 14 has moved to one side.

The camera module 3000, according to the present embodiment, is different from the first embodiment in terms of the arrangement of the first damper 500 and the position of the opening 312. Therefore, in describing the present embodiment, only the arrangement of the first damper 500 and the position of the opening 312, which are different from those of the first embodiment of the present disclosure, will be described, and the same description of the first embodiment of the present disclosure may be applied to the other components as is.

Referring to FIGS. 13 to 15, the first damper 500 of the present embodiment may be disposed on the inner surface of the housing 110. In addition, the carrier 310 of the present embodiment may include the opening 312 connected to the concave portion 311 and being open toward the housing 110. That is, the opening 312 of the present embodiment may be formed in the-X direction. The first damper 500 may be accommodated in the concave portion 311 by passing through the opening 312. That is, the first damper 500 of the present embodiment may be accommodated in the concave portion 311 of the carrier 310 in the +X direction and may be damped with the inner surface of the concave portion 311 in the direction of the optical axis (the Z axis).

The first damper 500 of the present embodiment may include the first fixing portion 510 fixed to the housing 110 and the first buffer portion 520 coupled to the first fixing portion 510.

The first fixing portion 510 may be configured to firmly support the first damper 500 and may be formed of a non-magnetic metal material. For example, the first fixing portion 510 may include at least one of SUS, Al, Ti, Cu, and Cu-Zn, but is not limited thereto. The first fixing portion 510 may be integrated with the housing 110 through welding.

Meanwhile, referring to FIG. 14, the first fixing portion 510 of the present embodiment may include the first region 511 contacting the housing 110 and the second region 512 extending from the first region 511 to both sides in the optical axis (the Z-axis) direction. That is, the first fixing portion 510 may have a T-shaped cross-section, including the first region 511 extending in the first axis (the X-axis) direction and the second region 512 branching from the first region 511 to both sides.

In addition, the first buffer portion 520 may be coupled to the first fixing portion 510 and may be formed of an elastic material. The first buffer portion 520 may include a buffering material, such as, for example, a liquid crystal polymer (LCP), urethane, silicone, rubber, foam resin, epoxy, poly material, etc.

The first buffer portion 520 may be coupled to the second region 512 of the first fixing portion 510 and may be disposed to face the inner surface of the concave portion 311 in the optical axis (the Z-axis) direction. Through this structure, when the carrier 310 is driven in the optical axis (the Z-axis) direction, buffering between the first damper 500 and the inner surface of the concave portion 311 may be implemented.

Referring to FIG. 15, based on the optical axis (the Z-axis) direction, the maximum gap G1 between the first damper 500 and the inner surface of the concave portion 311 may be narrower than the maximum gap G2 between the second damper 600 and the outer surface of the carrier 310. Through this structure, when the carrier 310 moves in the optical axis (the Z-axis) direction, a collision between the inner surface of the concave portion 311 and the first damper 500 may occur first. After the collision, a collision between the outer surface of the carrier 310 and the second damper 600 may occur.

Therefore, when the carrier 310 moves to the maximum driving range in the optical axis (the Z-axis) direction, the carrier 310 may sequentially collide with the first damper 500 and the second damper 600. Through this dual damping structure, the impact applied to the carrier 310 and the counterpart in the optical axis (the Z-axis) direction may be effectively alleviated and the risk of noise occurrence and breakage may also be reduced.

The camera module, according to an embodiment of the present disclosure, may reduce the magnitude of the noise that may occur during driving for autofocusing.

In addition, the camera module according to an embodiment of the present disclosure may effectively buffer impact between components in the optical axis direction, thereby reducing the risk of breakage.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
a reflective member disposed within the housing and configured to change an optical path;
a lens module comprising a carrier movable along an optical axis direction, the carrier comprising a concave portion on a side surface and at least one lens disposed therein;
a case coupled to the housing to cover the reflective member and the lens module; and
a first damper disposed on an inner surface of the housing or the case and having at least a portion accommodated within the concave portion.

2. The camera module of claim 1, further comprising a second damper fixed to the housing and facing an outer surface of the carrier along the optical axis direction.

3. The camera module of claim 2, wherein a maximum gap between the first damper and an inner surface of the concave portion is smaller than a maximum gap between the second damper and the outer surface of the carrier in the optical axis direction.

4. The camera module of claim 2, wherein, in response to the carrier moving to a maximum driving range in the optical axis direction, the carrier sequentially contacts the first damper and the second damper.

5. The camera module of claim 1, wherein the first damper comprises a first fixing portion fixed to the case and a first buffer portion coupled to the first fixing portion.

6. The camera module of claim 5, wherein the first buffer portion faces an inner surface of the concave portion in the optical axis direction.

7. The camera module of claim 5, wherein the first fixing portion comprises a first region in contact with the case and a second region extending in a first direction from the first region to both sides in the optical axis direction different from the first direction.

8. The camera module of claim 5, wherein the first fixing portion comprises a non-magnetic metal material, and the first buffer portion comprises an elastic material.

9. The camera module of claim 1, wherein
the concave portion is disposed on both side surfaces at an outer surface of the carrier facing each other in a direction perpendicular to the optical axis direction, and
the first damper comprises a plurality of first dampers respectively accommodated in the concave portion on both side surfaces of the carrier.

10. The camera module of claim 2, wherein the second damper comprises a second fixing portion fixed to the housing and a second buffer portion coupled to the second fixing portion.

11. The camera module of claim 2, wherein
the carrier comprises an opening connected to the concave portion and open toward the case, and
the first damper is integrally formed and at least a portion of the first damper is accommodated in the opening.

12. The camera module of claim 11, wherein the first damper faces the inner surface of the opening in the optical axis direction.

13. The camera module of claim 11, wherein a maximum gap between the first damper and an inner surface of the opening is smaller than a maximum gap between the second damper and the outer surface of the carrier.

14. The camera module of claim 11, wherein the first damper is disposed in an accommodation recess disposed on the inner surface of the case.

15. A camera module comprising:
a housing;
a reflective member disposed within the housing and configured to change an optical path;
a lens module comprising a carrier movable along an optical axis direction, and at least one lens disposed in the carrier;
a case coupled to the housing to cover the reflective member and the lens module; and
a first damper disposed on an inner surface of the housing or the case and having both end portions facing the carrier in the optical axis direction.

16. The camera module of claim 15, wherein the carrier comprises a concave portion disposed on a side surface, and an opening connected to the concave portion and open toward the housing, and
wherein the first damper is accommodated in the concave portion through the opening.
